(19) United States
(12) Patent Application Publication
(10) Pub. No.: US 2014/0058748 A1
(43) Pub. Date: Feb. 27, 2014

(54) POPULATING CUSTOM PATIENT WORKLISTS USING DEMOGRAPHIC AND CLINICAL CRITERIA

(71) Applicants: Erica Lorraine FORD, Gladstone, MO (US); Rachel Lee COOMBE, Kansas City, MO (US); Niklas Christian Boive FORSBERG, Lee's Summit, MO (US)

(72) Inventors: Erica Lorraine FORD, Gladstone, MO (US); Rachel Lee COOMBE, Kansas City, MO (US); Niklas Christian Boive FORSBERG, Lee's Summit, MO (US)

(73) Assignee: CERNER INNOVATION, INC., Lenexa, KS (US)

(21) Appl. No.: 13/592,623

(22) Filed: Aug. 23, 2012

(51) Int. Cl. G06Q 50/24

(52) U.S. Cl. 705/3

(57) ABSTRACT

Systems, methods, computer-readable media, and graphical user interfaces for creating custom patients worklists are provided. In embodiments, demographic and clinical criteria are used to create custom patient worklists. Patient lists and units associated with healthcare facilities are selected. Names of views associated with the custom patient worklists are received. Criteria are selected and sequences for displaying selected criteria are received. Custom patient worklists are built based on the selections.

### BACKGROUND

Patient medical information, such as that contained in a medical record, allows health care providers to provide continuity of care to patients. Thus, it is critical for clinicians providing care to patients to review and update each patient's medical record. The type of care, review, and updates required often vary based on the type of patient and area within a healthcare facility the clinician is responsible for on any given day. In some cases, a clinician may have responsibilities associated with multiple types of patients in multiple units of multiple healthcare facilities. In other cases, a clinician may have responsibility for a single type of patient, unit, or healthcare facility. In other cases, a clinician may have a variety of responsibilities based on day of the week or a location. In each of these instances, the task of searching for a particular patient or review a piece of information within the patient's medical record is extremely time consuming and inefficient.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to methods, systems, graphical user interfaces, and computer readable media for populating custom patient worklists using demographic and clinical criteria. Embodiments of the present invention enable a clinician to save a view or custom patient lists that are currently displayed for ease of use the next time the custom patient worklist is accessed. Embodiments of the present invention allow clinicians to select demographic and clinical criteria to populate a custom patient worklist with a list of patients associated with the relevant clinical data so the clinician can more easily manage their work day. Embodiments of the present invention enable a clinician to create multiple custom patient worklists corresponding to a work day, a facility, a type of patient, and the like. Accordingly, in one embodiment, computer storage media having computer-executable instructions embodied thereon that, when executed, facilitate a method of creating custom patient worklists. A selection of a patient list for a healthcare facility is received. A name of a view associated with a custom patient worklist is received. A selection of a unit within the healthcare facility is received. A selection of one or more criteria associated with the patient list is received. A selection of a sequence to display the selection of one or more criteria is received. The custom patient worklist is built based on the selections.

In another embodiment, a computer system, comprising a processor coupled to a computer storage medium, the computer storage medium having stored thereon a plurality of computer software components executable by the processor, for creating custom patient worklists is provided. A patient list component receives a selection of a patient list for a healthcare facility. A view component receives a name of a view associated with a custom patient worklist. A unit component receives a selection of a unit within the healthcare facility. A category component receives a selection of one or more criteria associated with the patient list. A sequence component receives a selection of a sequence to display the selection of one or more criteria. A build component builds the custom patient worklist based on the selections.

In another embodiment, computer storage media having computer-executable instructions embodied thereon that, when executed, produce a graphical user interface (GUI) to facilitate automating displays based on admissions, discharges, and transfers. A patient list display area is configured to display a selectable list of patients within a healthcare facility. A view display area is configured to display an editable name of a view associated with the patient list. A unit display area is configured to display a selectable list of units associated with the healthcare facility. Criteria display area is configured to display a prepopulated selectable list of criteria based on the selections. A sequence display area is configured to display a tool for modifying a sequence associated with the selected criteria.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is an exemplary system architecture suitable for use in implementing embodiments of the present invention;

FIGS. 3 is a flow diagram of a method in accordance with an embodiment of the present invention; and

FIGS. 4-5 are illustrative screen displays in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Having briefly described embodiments of the present invention, an exemplary operating environment suitable for use in implementing embodiments of the present invention is described below.

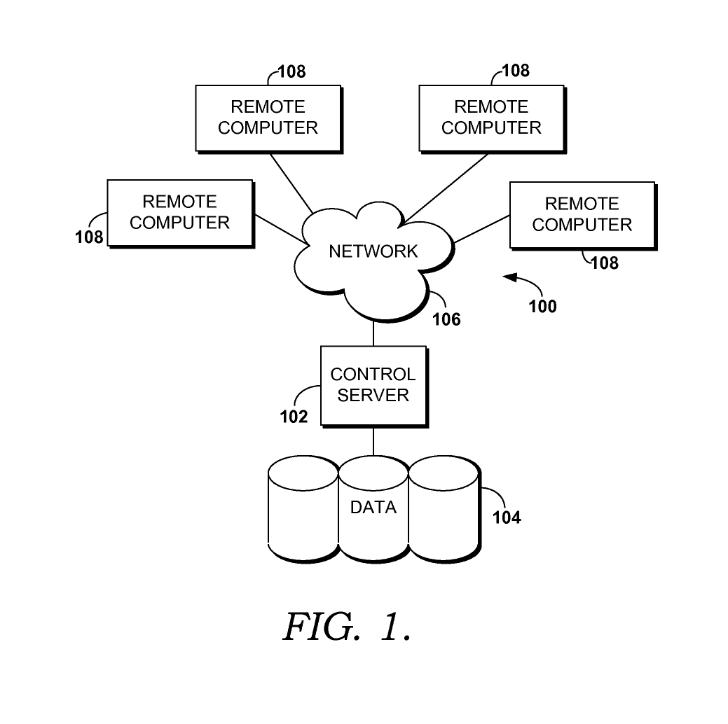

Referring to the drawings in general, and initially to FIG. 1 in particular, an exemplary computing system environment, a medical information computing system environment, with which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 100 includes a general purpose computing device in the form of a control server 102. Components of the control server 102 may include, without limitation, a processing unit, internal system memory, and a suitable system bus for coupling various system components, including database cluster 104, with the control server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 102. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the control server 102. The control server 102 may operate in a computer network 106 using logical connections to one or more remote computers 108. Remote computers 108 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as intensivists, surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the elements described above in relation to the control server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the control server 102 may include a modem or other means for establishing communications over the WAN, such as the Internet. In a networked environment, program modules or portions thereof may be stored in association with the control server 102, the database cluster 104, or any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) may be utilized.

In operation, a clinician may enter commands and information into the control server 102 or convey the commands and information to the control server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 102. In addition to a monitor, the control server 102 and/or remote computers 108 may include other peripheral output devices, such as speakers and a printer.

Although many other internal components of the control server 102 and the remote computers 108 are not shown, those of ordinary skill in the art will appreciate that such components and their interconnection are well known. Accordingly, additional details concerning the internal construction of the control server 102 and the remote computers 108 are not further disclosed herein.

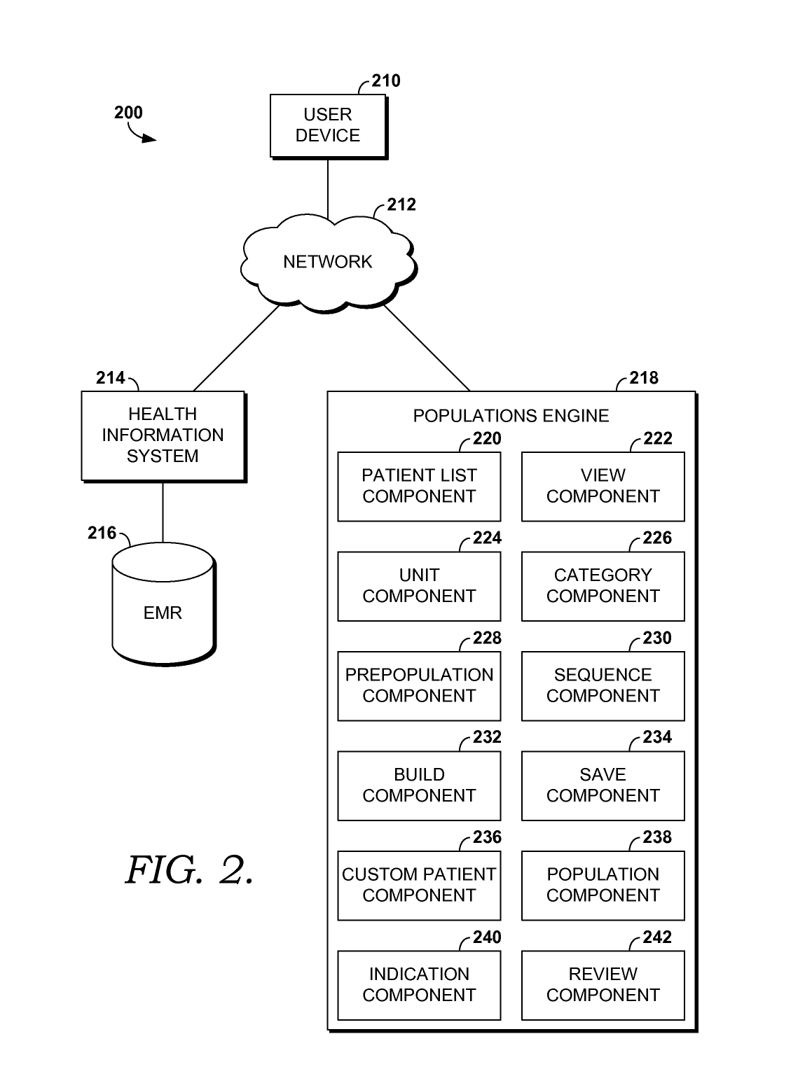

With reference to FIG. 2, a block diagram is illustrated that shows an exemplary computing system 200 architecture for automatically opening and closing patient information. It will be appreciated that the computing system architecture shown in FIG. 2 is merely an example of one suitable computing system and is not intended as having any dependency or requirement related to any single module/component or combination of modules/components.

The computing system 200 includes one or more user devices 210, network 212, health information system 214, electronic medical record (EMR) 216, and population engine 218. As utilized herein, the acronym “EMR” is not meant to be limiting, and may broadly refer to any or all aspects of the patient's medical record rendered in a digital format. Generally, the EMR is supported by systems configured to co-ordinate the storage and retrieval of individual records with the aid of computing devices. As such, a variety of types of healthcare-related information may be stored and accessed in this way. By way of example, the EMR may store one or more of the following types of information: patient demographic; medical history (e.g., examination and progress reports of health and illnesses); medicine and allergy lists/immunization status; laboratory test results, radiology images (e.g., X-rays, CTs, MRIs, etc.); evidence-based recommendations for specific medical conditions; a record of appointments and physician's notes; billing records; and data received from an associated medical device.

User device 210 allows a clinician to access health information system 214, EMR 216, and population engine 218 via network 212. Although health information system 214, EMR, 216, and population engine 218 are illustrated in FIG. 2 as separate components of computing system 200, it should be appreciated that one or more of these components may be included in a single computing device.

Population engine 218 may reside on one or more computing devices, such as, for example, the control server 102 described above with reference to FIG. 1. By way of example, the control server 102 includes a computer processor and may be a server, personal computer, desktop computer, laptop computer, handheld device, mobile device, consumer electronic device, or the like.

In various embodiments, population engine 218 comprises patient list component 220, view component 222, unit component 224, category component 226, prepopulation component 228, sequence component 230, build component 232, save component 234, custom patient component 236, population component 238, indication component 240, and review component 242. Patient list component 220 receives a selection of a patient list for a healthcare facility. In one embodiment, the patient list represents a particular category or type of patients. For example, a clinician may have a responsibility associated with diabetes management for a group of patients. Because the clinician may have additional responsibilities associated with other categories of patients, the clinician may desire to create and save a custom patient worklist associated with diabetes management patients.

After patient list component 220 receives the selection of a patient list, view component 222 receives a name of a view associated with a custom patient worklist. Continuing the example above, the clinician may name the view for one custom patient worklist “Diabetes Management”. The view name allows a clinician to distinguish between various created and saved custom patient lists. Each time the clinician logs into user device 210, the view names associated with one or more created custom patient lists are displayed in a populations view. In one embodiment, a default custom patient list is displayed upon log in and a clinician may view another custom patient list by selecting the appropriate view name from the populations view.

Unit component 224 receives a selection of a unit within the healthcare facility. For example, the clinician responsible for diabetes management may desire to further distinguish among patient. That responsibility may be isolated to patients in the intensive care unit or medical/surgical patients. Depending on what unit within a healthcare facility diabetes patients are located, diabetes management may involve different protocols or may require different levels of review. The clinician may want to create and save separate custom patient worklists for each patient list corresponding to units within a healthcare facility.

Category component 226 receives a selection of one or more criteria associated with the view. In one embodiment, a risk list of criteria is prepopulated for a patient list by prepopulation component 228. For example, if a clinician selects diabetes management for the patient list, various criteria associated with diabetes are prepopulated into a risk list. The clinician is able to select one or more of the criteria from the risk list that enable data associated with each of the selected criteria to be displayed in the custom patient worklist.

Once the desired criteria are selected, sequence component 230 receives a selection of a sequence in which to display the selection of one or more criteria. This allows the clinician to customize the appearance of the custom patient worklist. For example, a particular criterion may be more critical to a clinician than another criterion. The clinician may desire to have that criteria in a more prominent or visible area of the display than the less critical criteria. Accordingly, the clinician moves the more critical criteria higher in the list of selected criteria so more critical criteria is displayed in a column before the less critical criteria.

Once each of the selections is received, build component 232 builds the custom patient worklist based on the selections. Thus, each of the various columns representing criteria are created in the sequence desired for the particular type of patient in the particular unit of the healthcare facility. In one embodiment, save component 234 saves the custom patient worklist to a populations view (i.e., name of the view associated with the custom patient worklist). As described briefly above, names of views associated with the saved custom patient worklists are displayed when a clinician logs into the system in the populations view. In one embodiment, a default custom patient worklist is designated by the clinician so a frequently accessed custom patient worklist is displayed automatically upon login.

In one embodiment, custom patient component 236 receives a selection of a custom patient worklist. The clinician selects the custom patient worklist by selecting a name of the view associated with the desired custom patient worklist that is displayed in the populations view. Once selected, population component 238 automatically populates the custom patient worklist for the clinician. This allows the custom patient worklists to be dynamic and up-to-date because although the columns are created by build component 232, the rows are populated by population component 238 upon selection. The information retrieved and used to populate the custom patient worklist by population engine 218 includes data and other information stored by health information system 214 and/or EMR 216. In one embodiment, population engine 218 may receive real-time data from health information system 214 and/or EMR 216. For clarity, real-time includes near real-time, taking into account latency or other typical delays between one or more devices communicating in a networked environment.

In one embodiment, indication component 240 receives an indication that one or more items within the custom patient worklist are to be reviewed by a second clinician. After a first clinician selects the items that should be reviewed by the second clinician, indication component 240 communicates these items to review component 242. Review component 242 populates a review worklist for the second clinician. The review worklist is created and saved to a populations view associated with and accessible by the second clinician. For example, a nurse practitioner may be responsible for reviewing a worklist associated with a particular type of patient. If the nurse practitioner determines that a collaborating physician should review a particular item within the worklist or an item associated with a particular patient, the nurse practitioner can select that item within the nurse practitioner's custom patient worklist. The nurse practitioner can further designate which clinician should review the item. Indication component 240 receives this indication and communicates the item (i.e., a particular row representing a patient) to review component 242. Review component 242 populates a review worklist for the designated clinician or clinicians.

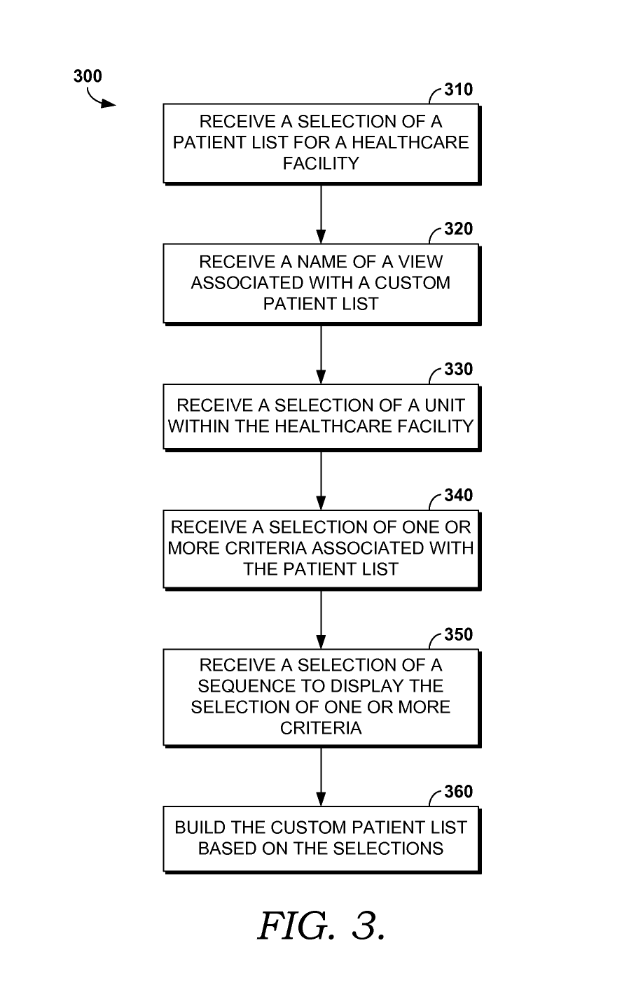

Referring now to FIG. 3, an illustrative flow diagram 300 is shown of a method for creating custom patient worklists, in accordance with embodiments of the present invention. At step 310, a selection of a patient list for a healthcare facility is received. In one embodiment, the patient list represents a particular category of patients. In one embodiment, a list of available patient lists is provided, such as in a drop-down menu for selection by the clinician creating the custom patient worklist. The list of available patient lists is associated with or dependent upon, in one embodiment, a specialty, privileges, credentials, or skill set of the clinician creating the custom patient worklist. In another embodiment, the list of available patient lists is dependent on one or more healthcare facilities the clinician is associated with. A name of a view associated with a custom patient list is received at step 320.

At step 330, a selection of a unit within the healthcare facility is received. In one embodiment, a list of available units is provided, such as in a drop-down menu for selection by the clinician creating the custom patient worklist. The list of available units is associated with or dependent upon, in one embodiment, a specialty, privileges, credentials, or skill set of the clinician creating the custom patient worklist. In another embodiment, the list of available units is dependent on one or more healthcare facilities the clinician is associated with.

A selection of one or more criteria associated with the custom patient worklist is received at step 340. In one embodiment, a risk list of criteria is prepopulated for the patient list. In one embodiment, the risk list represents common criteria or suggested filters associated with a particular category of patients. In one embodiment, the risk list represents criteria defined by the health care facility. For example, once the patient type or patient list selection is received, common criteria that are often associated with, or more specifically, need to be monitored for that patient type are prepopulated into a risk list. The clinician creating the custom patient worklist can select from the risk list the desired criteria for the custom patient worklist. These criteria represent the columns containing data that appear in the custom patient worklist.

At step 350, a selection of a sequence to display the selection of one or more criteria is received. As noted above, the selection of criteria represent the columns that are displayed in the custom patient worklist. For example, a clinician may desire to customize the appearance of the custom patient worklist. This allows the clinician to select the sequence of the columns or criteria so that a particular criteria that is of greater importance to the clinician appears more prominently or higher (i.e., before) in the custom patient worklist than a criteria that is of lower importance.

At step 360, the custom patient worklist is built based on the selections. Any queries or logic necessary to extract the data from the health information system or EMR is created to include the items selected by the clinician. In one embodiment, the custom patient worklist is saved to a populations view. For example, once the custom patient worklist is built, the clinician can save the custom patient worklist so the custom patient worklist can be viewed at a later time. A link identifying the custom patient worklist is displayed in the populations view so the clinician can easily locate and select the desired custom patient worklist. If a clinician has created a custom patient worklist based on a day of the week, a location, or a type of patient or responsibility, the clinician can quickly display a dynamic worklist at any particular time.

In one embodiment, a selection of the custom patient worklist is received. For example, a pharmacist may have duties associated with a day of the week. On Monday, the clinician may monitor anticoagulation patients in an anticoagulation clinic. On Tuesday and Thursday, the pharmacist may monitor all ICU and Cardiac Unit patients. On Wednesdays and Fridays, the pharmacist may have antibiotic surveillance with an Infection Control Team. Thus, once the pharmacist has created the custom patient worklists for each of these items, the pharmacist can locate the link identifying the proper custom patient worklist for a particular day of the week and select that link. Once selected, in one embodiment, the custom patient worklist is automatically populated.

In another example, a clinician may be responsible for diabetes management for both ICU and medical/surgical patients. The clinician may further wish to distinguish between the two types of patients. For example, the clinician may determine that for ICU patients, it is necessary to monitor insulin drips, follow strict protocols based on blood glucose taken every hour. However, because ICU patients are typically no food/water by mouth (NPO), the clinician is not interested in monitoring calorie intake and percentage of meal consumed. To the contrary, insulin drips are not typically used on medical/surgical patients, and blood glucose is monitored only 3-4 times per day. Further, calorie intake and percentage of meal consumed is monitored in medical/surgical patients. The clinician can make the necessary selections to include the appropriate columns (i.e., criteria) to create the custom patient worklists for each type of patient. After the custom patient worklists have been created, the clinician can locate the desired link identifying the type of patient the clinician is interested in reviewing and select that link. Again, once selected, in one embodiment, the custom patient worklist is automatically populated.

In one embodiment, an indication that one or more items within the worklist are to be reviewed by a second clinician. For example, a team of clinicians may be responsible for a particular patient or group of patients. The team may include a nurse, a nurse practitioner, a physician, and the like. In the process of reviewing the custom patient worklist, one clinician may identify an item that needs further review or requires escalation. For example, a nurse practitioner may indicate that an item should be escalated to the nurse practitioner's collaborating physician. Once the indication is received, in one embodiment, a review worklist is populated for the second clinician (e.g., the collaborating physician.).

In one embodiment, tabs are utilized to separate or organize items from the custom patient worklist. For example, separate tabs can be utilized for inpatient and outpatient patients. Or, separate tabs can be utilized to distinguish between patients that need assessments, have ongoing assessments or are low risk, or have already been assessed.

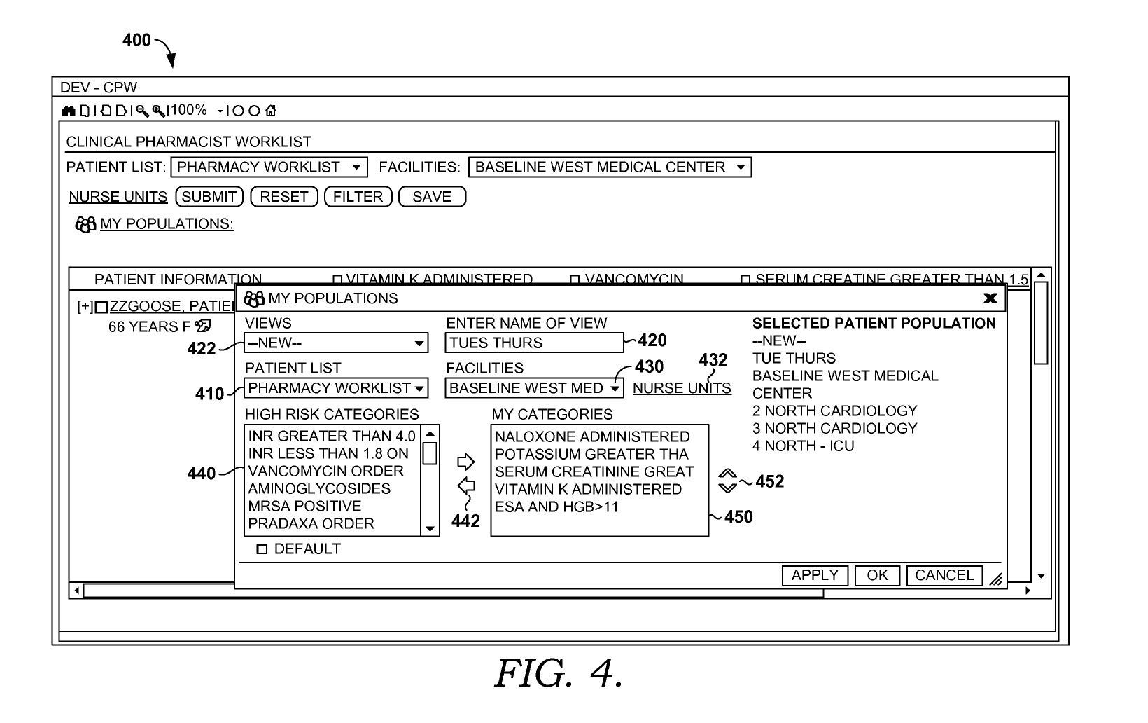

Referring now to FIG. 4, in an illustrative screen display 400, patient list display area 410 is configured to display a selectable list of patients within a healthcare facility. As described above, the list of patients, in one embodiment, represents a particular type or category of patients. View display area 420 is configured to display an editable name of a view associated with the patient list. In one embodiment, view display area includes a drop-down menu 422 for selecting a previously created view or an option to create a new view. Unit display area 430 is configured to display a selectable list of units associated with the healthcare facility. In one embodiment, unit display area 430 is a drop-down menu corresponding to a unit within the healthcare facility. In another embodiment, unit display area 430 is further configured to include a selectable button 432 to display nurse units within the healthcare facility. Criteria display area 440 is configured to display a prepopulated selectable list of criteria based on the selections. For example, based on the selections made in the patient list display area 410, the view display area 420, and the unit display area 430, the criteria display area is configured to displayed criteria recommended to be included in the custom patient worklist. In one embodiment, a criteria selection button 442 allows a clinician to include or exclude selected criteria. Sequence display area 450 is configured to display a tool for modifying a sequence associated with the selected criteria. In one embodiment, sequence button 452 allows the clinician to move the selected criteria up or down. This allows the clinician to customize the appearance of the custom patient worklist by modifying the sequence of the columns.

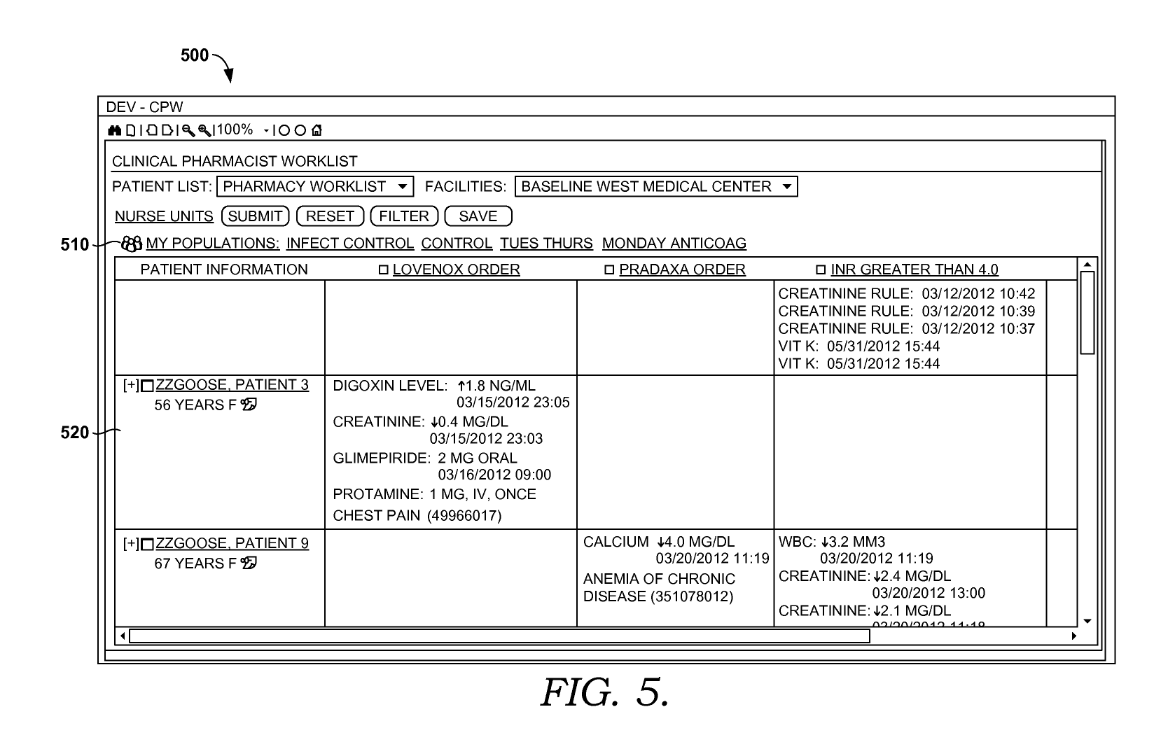

Referring now to FIG. 5, in an illustrative screen display 500, populations display area 510, in one embodiment, is configured to display available populations. The available populations represent a link to the custom patient worklists. In one embodiment, custom patient worklist area 520 is configured for displaying the populated custom patient worklist in response to selecting the link.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer storage media having computer-executable instructions embodied thereon that, when executed, facilitate a method of creating custom patient worklists, the method comprising:
receiving a selection of a patient list for a healthcare facility;
receiving a name of a view associated with a custom patient worklist;
receiving a selection of a unit within the healthcare facility;
receiving a selection of one or more criteria associated with the patient list;
receiving a selection of a sequence to display the selection of one or more criteria; and
building the custom patient worklist based on the selections.

2. The media of claim 1 wherein the custom patient worklist is saved to a populations view.

3. The media of claim 2, further comprising receiving a selection of the custom patient worklist.

4. The media of claim 3, further comprising automatically populating the custom patient worklist for a clinician.

5. The media of claim 4, further comprising receiving an indication that one or more items within the custom patient worklist are to be reviewed by a second clinician.

6. The media of claim 5, further comprising populating a review worklist for the second clinician.

7. The media of claim 1, wherein the patient list represents a particular category of patients.

8. The media of claim 1, further comprising prepopulating a risk list of criteria for the patient list.

9. The media of claim 8, wherein the risk list represents common criteria associated with a particular category of patients.

10. The media of claim of claim 8, wherein the risk list represents criteria defined by the health care facility.

11. A computer system for creating custom patient worklists, the computer system comprising a processor coupled to a computer storage medium, the computer storage medium having stored thereon a plurality of computer software components executable by the processor, the computer software components comprising:
a patient list component for receiving a selection of a patient list for a healthcare facility;
a view component for receiving a name of a view associated with a custom patient worklist;
a unit component for receiving a selection of a unit within the healthcare facility;
a category component for receiving a selection of one or more criteria associated with the patient list;
a sequence component for receiving a selection of a sequence to display the selection of one or more criteria; and
a build component for building the custom patient worklist based on the selections.

12. The system of claim 11, further comprising a save component for saving the custom patient worklist to a populations view.

13. The system of claim 11, further comprising a custom patient component for receiving a selection of the custom patient worklist.

14. The system of claim 11, further comprising a population component for automatically populating a custom patient worklist for a clinician.

15. The system of claim 11, further comprising an indication component for receiving an indication that one or more items within the custom patient worklist are to be reviewed by a second clinician.

16. The system of claim 11, further comprising a review component for populating a review worklist for the second clinician.

17. The system of claim 11, further comprising a prepopulation component for prepopulating a risk list of criteria for a patient list.

18. Computer storage media having computer-executable instructions embodied thereon that, when executed, produce a graphical user interface (GUI) to facilitate creating custom patient worklists, the GUI comprising:
a patient list display area configured to display a selectable list of patients within a healthcare facility;
a view display area configured to display an editable name of a view associated with the patient list;
a unit display area configured to display a selectable list of units associated with the healthcare facility;
a criteria display area configured to display a prepopulated selectable list of criteria based on the selections; and
a sequence display area configured to display a tool for modifying a sequence associated with the selected criteria.

19. The media of claim 18, wherein the GUI further comprises a populations display area configured to display available populations.

20. The media of claim 19, wherein the GUI further comprises a custom list area for displaying a populated custom patient in response to selecting a link associated with the available populations.
